(19) United States
(12) Patent Application Publication
(10) Pub. No.: US 2006/0170788 A1
(43) Pub. Date: Aug. 3, 2006

(54) Image sensor with balanced switching noise

(75) Inventor: Nadav Melamud, Kfar (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TransChip, Inc., Ramat Gan (IL)

(21) Appl. No.: 11/344,731

(22) Filed: Jan. 31, 2006

Related U.S. Application Data
(60) Provisional application No. 60/649,904, filed on Feb. 3, 2005.

(51) Int. Cl. H04N 5/225

(52) U.S. Cl. 348/222.1; 348/207.99

(57) ABSTRACT

An image sensor for producing a moving or still picture is disclosed. The image sensor includes an imaging array, a digital image processor, and a multiplexer. The multiplexer is coupled to both the imaging array and the digital image processor. The multiplexer includes a plurality of inputs, a plurality of switches, an output, and a select function. The select function selectively causes coupling of one of the plurality inputs to the output, wherein switching to any of the plurality of inputs results in a predetermined number of plurality of switches either opening or closing.

This application claims the benefit of and is a non-provisional of U.S. Provisional Application Ser. No. 60/649,904 filed on Feb. 3, 2005, which is assigned to the assigner hereof and hereby expressly incorporated by reference in its entirety for all purposes.

### BACKGROUND

This disclosure relates in general to multiplexers and, but not by way of limitation, to image sensors with multiplexed readouts of pixel lines for imaging array.

Pixel voltages are read from a CMOS image sensor (CIS) row-by-row by multiplexing the row into a serial signal. Pixel voltages are pre-processed serially by a number of analog circuits, which is less than the number of pixels in an array of the CIS. Additionally, the pre-processed analog voltages are further processed by a single analog device such as an analog to digital converter (ADC). Multiplexers are used to combine the many signals into a single serial stream or couple many signals to a common point.

Noise patterns noticeable in a picture reduce perceived image quality. A designer of CIS tries to reduce not only the noise of the pictures, but also the perceived image quality, as judged by the human viewer. For example, a picture in which the upper-half has some amount of visible random noise and the lower-part has less noise is perceived as having less quality that one where the noise is spread uniformly over the entire picture.

Another example of reduced image quality is fixed pattern noise (FPN)—if two picture sequences exhibit the same noise root mean square (RMS), but the noise is in fixed locations in one, and in varying locations (from image to image) in the other. The picture sequence with the FPN will be perceived as considerably worse. CIS designers use techniques to minimize the FPN. In some cases, the noise RMS is even increased purposefully to decrease FPN to assure that the image would exhibit less fixed pattern characteristics.

One of the sources of FPN in conventional systems occurs as a result of the analog multiplexing of column voltages read from the image array. This FPN is forwarded to analog processing units such as a Track&Hold circuit, for example, which then process the column voltages. A similar problem occurs when the output of the Track&Hold circuits are forwarded to a further analog processing unit like an analog to digital converter (ADC). As there are typically more columns in an imaging array than there are analog processing units, analog multiplexers are used to serially present the voltages of several columns to a single analog processing unit. The noise which occurs as a result of the switching between multiplexer inputs is of fixed pattern characteristics, and typically appears as vertical stripes of varying noise levels in the image.

In conventional systems, the switching method in the analog multiplexer generates a varying switching noise. When the inputs are scanned sequentially, a varying number of switches need to be toggled as the analog multiplexer couples its inputs to the output. This noise can be seen in the image.

### BRIEF DESCRIPTION OF THE DRAWINGS

The present disclosure is described in conjunction with the appended figures:

FIG. 1 depicts a block diagram of an embodiment of an image sensor;

FIGS. 2A and 2B depict block diagrams of embodiments of a multiplexer;

FIG. 3 depicts a block diagram of a conventional 32 to 1 (32:1) switch with variable switching noise when switching sequentially through the inputs;

FIG. 4 depicts a block diagram of an embodiment of a 32:1 switch with uniform switching noise having three layers of sub-multiplexers;

FIG. 5 depicts a block diagram of another embodiment of a 32:1 switch with uniform switching noise having two layers of sub-multiplexers;

FIG. 6 depicts a block diagram of yet another embodiment of a 32:1 switch with uniform switching noise having one layer of sub-multiplexers; and

FIG. 7 depicts a timing diagram showing signals within a switch.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Switching of circuits coupled to an imaging array can cause noise in a resulting image produced by the imaging array. In one embodiment, an analog multiplexer for use with the sequential readout of array voltages in circuits such as CMOS image sensors is disclosed. The architecture of the new multiplexer assures a constant number of switching when the array is scanned sequentially, thus eliminating an artifact whereas the read columns exhibit a horizontal sequence of noise levels.

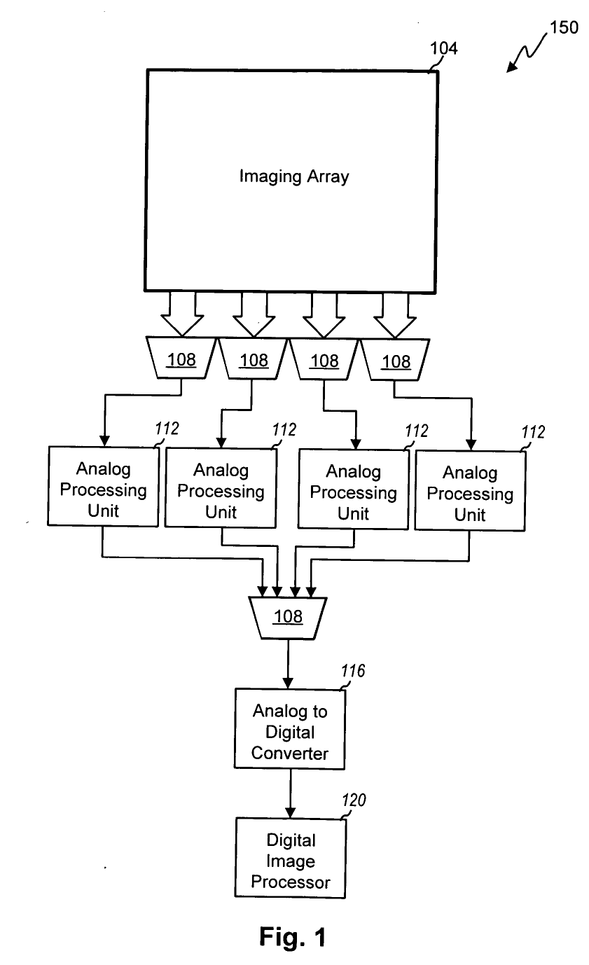

Referring initially to FIG. 1, a block diagram of an embodiment of an image sensor 150 is shown. In this embodiment, there are multiplexers 108 used in two different portions of the image sensor 150, but there could be many more multiplexers that are not shown. This image sensor 150 performs both analog processing and digital processing of an image captured by an imaging array 104. Digital switching noise can be coupled into the analog portions of the imaging sensor 150 in this embodiment. In this embodiment, a single chip or substrate is used to implement the image sensor 150, but other embodiments could separate the analog and digital circuitry, for example.

The imagining array 104 is exposed to a scene to capture an image in columns and rows. In this embodiment, the image in parallel to four different analog processing paths. A multiplexer 108 in each analog processing path serializes the fraction of the image into a single signal before passing to the analog processing unit 112. Certain image and signal enhancements are performed in the analog processing unit 112.

This embodiment only has a single analog-to-digital converter (ADC) 116 to process information from all analog processing paths. Another multiplexer 108 is positioned between the four analog processing units 112 and the ADC to combine the four signals into a single signal. The multiplexer is controlled such that imaging array 104 is spooled out a row or column at a time. Once in the digital domain after the ADC 116, further processing is performed in the digital image processor 120.

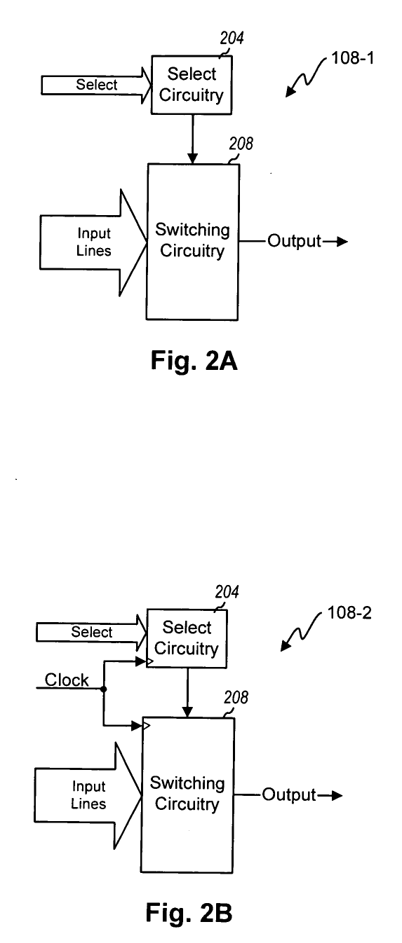

With reference to FIG. 2A, a block diagram of an embodiment of a multiplexer 108-1 is shown. A multiplexer 108 has select inputs and data inputs. According to the select inputs, a particular data input is passed as the output. The switching circuitry 208 is used to switch one of the data inputs to the output. Various switches or pass gates in the switching circuitry 208 are controlled by select circuitry 204. Decoding may be performed in the select circuitry 204. In one embodiment, the select input is a binary coded decimal BCD value that indicates the input line that should be coupled to the output.

Referring next to FIG. 2B, a block diagram of another embodiment of a multiplexer 108-2 is shown. In this embodiment, the select circuitry 204 and switching circuitry 208 are clocked. In one embodiment, the select circuitry 204 operates in one half of the clock period and the propagation through the switching circuitry takes place on the other half of the clock period. Using clocking, the multiplexer functions can be pipelined into stages.

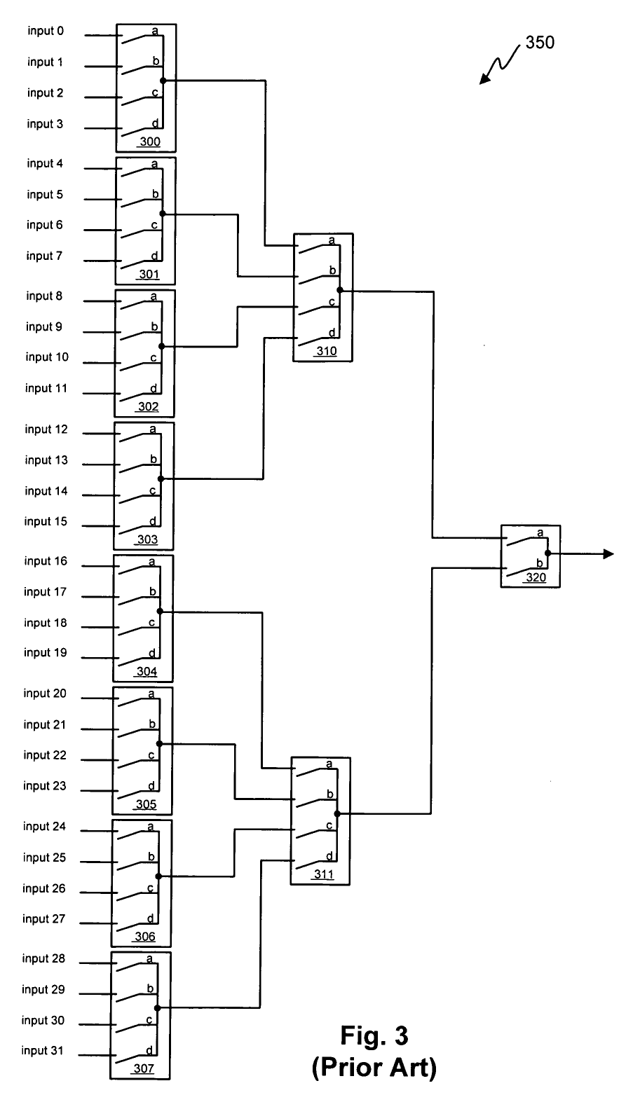

With reference to FIG. 3, a block diagram of a conventional 32:1 switch 350 is shown with variable switching noise when switching sequentially through the inputs. Thirty-two column outputs from the imaging array 104 are input to the conventional multiplexer, for example. This and subsequent figures do not show the select lines that would go to control each switch in each sub-multiplexer 300-307, 310, 311.

The 32 inputs are wired to eight 4-input sub-multiplexers 300-307. The outputs from those eight 4-input sub-multiplexers 300-307 are wired to two 4-input sub-multiplexers 310, 311. Lastly, the outputs of the two sub-multiplexers 310, 311 are wired to a 2-input sub-multiplexer 320. Regardless of level, each 4-input sub-multiplexer 300-307, 310, 311 comprises four switches, which are designated a, b, c, and d. The switches are typically implemented by n-type or p-type transistors, or a combination of n-type and p-type transistor pairs.

The following Table I shows the switches are closed or turned “on” for each multiplexer to couple a particular input to the output for input 8 through input 23. Table I shows switches to close for sequentially scanning through input 8 and ending with input 23, but could be extrapolated for the whole 32 to 1 multiplexer. The “switching” column shows the number of switches for closing when changing from the last input to the present input. Opening of switches may also create noise, but those effects are not discussed in detail. The same problems from closing differing amounts of switches is found in this conventional switching circuit 350.

TABLE I
Conventional Switching

| Input | Mux 302 | Mux 303 | Mux 304 | Mux 305 | Mux 310 | Mux 311 | Mux 320 | switching |
|---|---|---|---|---|---|---|---|---|
| 8 | a | | | | c | | a | — |
| 9 | b | | | | c | | a | 1 |
| 10 | c | | | | c | | a | 1 |
| 11 | d | | | | c | | a | 1 |
| 12 | | a | | | d | | a | 2 |
| 13 | | b | | | d | | a | 1 |
| 14 | | c | | | d | | a | 1 |
| 15 | | d | | | d | | a | 1 |
| 16 | | | a | | | a | b | 3 |
| 17 | | | b | | | a | b | 1 |
| 18 | | | c | | | a | b | 1 |
| 19 | | | d | | | a | b | 1 |
| 20 | | | | a | | b | b | 2 |
| 21 | | | | b | | b | b | 1 |
| 22 | | | | c | | b | b | 1 |
| 23 | | | | d | | b | b | 1 |

When the scan of inputs advances from input 8 to input 9, for example, a single sub-multiplexer 302 is affected. Specifically, switch a opens and switch b closes. The same number of switch changes will happen when stepping from input 9 to 10 and from input 10 to 11. However, when stepping from input 11 to 12, there is switching noise from two sub-multiplexers 303, 310. When stepping from input 15 to 16, three switches will switch on in three different sub-multiplex ers 304, 311, 320. As can be further observed from Table I, switching noise is caused by one, two or three switches closing. In general, the number of switches which change from off to on (and from on to off) varies from 1 to n in conventional systems, where n is the number of hierarchy levels of sub-multiplexers used.

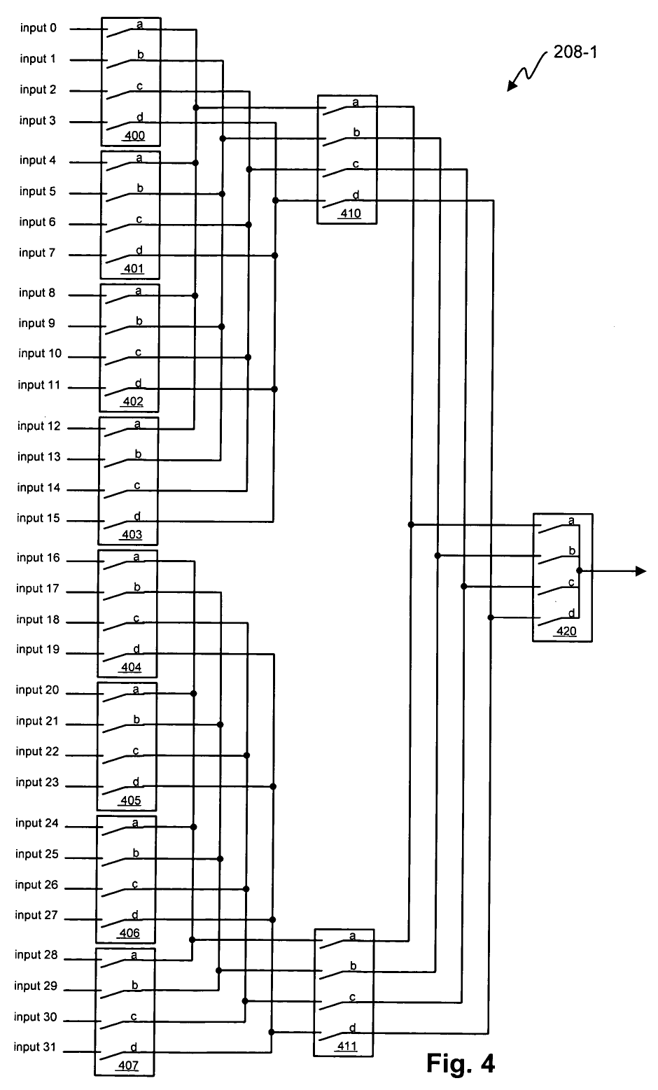

In general reference to FIGS. 4-6, three embodiments are shown, but these are mere examples and those of ordinary skill in the art will recognize other ways to implement the invention. These embodiments exhibit a fixed number of switches which change state when the selected input is changed or serially scanned. Generally, the hierarchical structure of conventional designs is modified to add buses between the hierarchy levels. The buses have multiple inputs to them. These embodiments allow a switching scheme where the number of switches changing state is equivalent to the number of levels, and remains unchanged as we step serially from input to input.

Referring next to FIG. 4, a block diagram of an embodiment of a 32:1 switching circuitry 208-1 with uniform switching noise is shown. When sequentially switching through the inputs, the switching in uniform. The switch closures for at least part of the switch 208-1, when inputs are scanned from 8 to 23, is summarized in Table II below. As can be seen, the number of switches closures (and openings) is fixed at three, and no fixed pattern noise results in this embodiment. The pattern of three switch openings and closings continues for all inputs as they are sequentially cycled over and over again.

This embodiment has three levels where there are eight sub-multiplexers 400-407 in the first layer, four sub-multiplexers 410-413 in the second layer and one sub-multiplexer 420 in the third layer. Other embodiments could have far more inputs into the switching circuitry 208, as may be required by the particular application. The select lines for each sub-multiplexer are individually manipulated in this embodiment.

TABLE II
Switch Closures for Three Layer Embodiment

| Input | Mux 402 | Mux 403 | Mux 404 | Mux 405 | Mux 410 | Mux 411 | Mux 420 | switching |
|---|---|---|---|---|---|---|---|---|
| 8 | a | | | | a | | a | — |
| 9 | b | | | | b | | b | 3 |
| 10 | c | | | | c | | c | 3 |
| 11 | d | | | | d | | d | 3 |
| 12 | | a | | | a | | a | 3 |
| 13 | | b | | | b | | b | 3 |
| 14 | | c | | | c | | c | 3 |
| 15 | | d | | | d | | d | 3 |
| 16 | | | a | | | a | a | 3 |
| 17 | | | b | | | b | b | 3 |
| 18 | | | c | | | c | c | 3 |
| 19 | | | d | | | d | d | 3 |
| 20 | | | | a | | a | a | 3 |
| 21 | | | | b | | b | b | 3 |
| 22 | | | | c | | c | c | 3 |
| 23 | | | | d | | d | d | 3 |

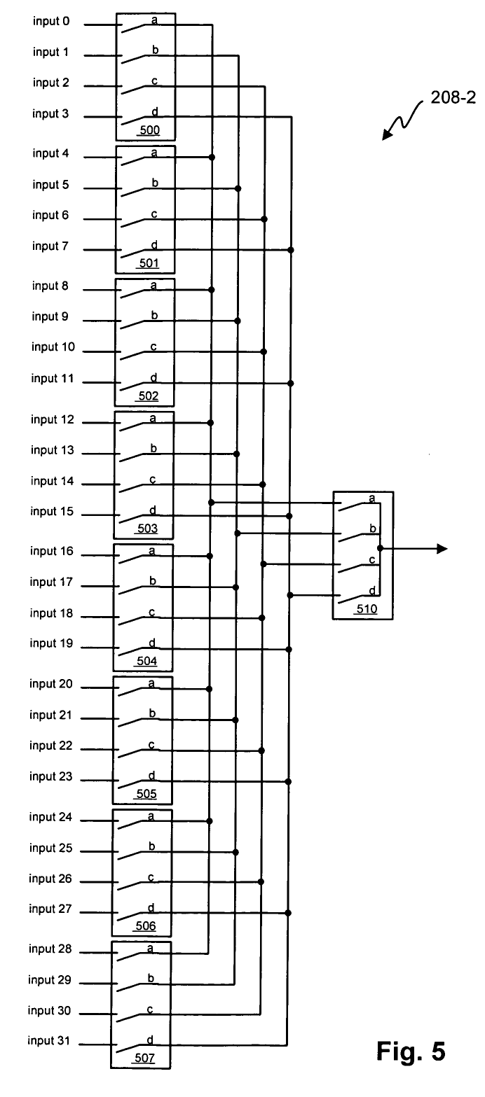

With reference to FIG. 5, a block diagram of another embodiment of a 32:1 switching circuit 208-2 is shown with uniform switching noise when switching sequentially through the inputs. There are two hierarchy levels in this embodiment, which uses a larger fan-out for each of first layer sub-multiplexers 500-507. The following Table III indicates switch closures for this embodiment, when inputs are scanned from input 16 to 23.

TABLE III
Switch Closures for Two Layer Embodiment

| | Mux | | | | | |
|---|---|---|---|---|---|---|
| Input | 502 | Mux 503 | Mux 504 | Mux 505 | Mux 510 | switching |
| 8 | a | | | | a | — |
| 9 | b | | | | b | 2 |
| 10 | c | | | | c | 2 |
| 11 | d | | | | d | 2 |
| 12 | | a | | | a | 2 |
| 13 | | b | | | b | 2 |
| 14 | | c | | | c | 2 |
| 15 | | d | | | d | 2 |
| 16 | | | a | | a | 2 |
| 17 | | | b | | b | 2 |
| 18 | | | c | | c | 2 |
| 19 | | | d | | d | 2 |
| 20 | | | | a | a | 2 |
| 21 | | | | b | b | 2 |
| 22 | | | | c | c | 2 |
| 23 | | | | d | d | 2 |

In this embodiment, the number of switches changing state is fixed at two openings and two closing, and no fixed pattern noise is introduced. Generally, the number of layers is equal to the number of switch openings or closings between each sequential input. Although, some embodiments contemplate sequential use of the inputs, other embodiments could select the inputs in non-sequential fashion so long as the switch openings and/or closings is the same when going from selecting one input to selecting another.

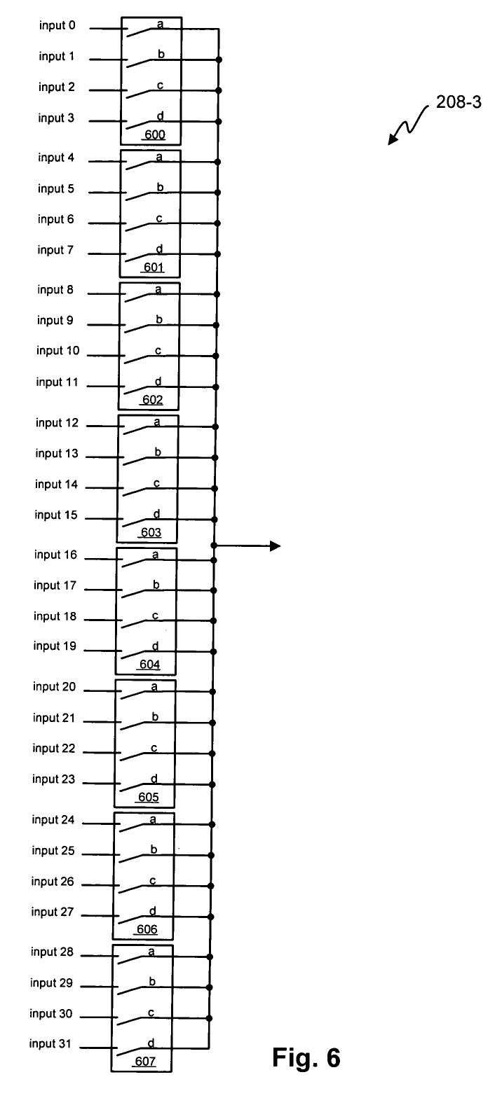

Referring next to FIG. 6, a block diagram of another embodiment of a 32:1 switching circuit 208-3 is shown with uniform switching noise when switching from a first selected input to a second selected input. This embodiment has a single level of sub-multiplexers 600-607 where all switch outputs are tied to a common bus. To switch from selection of a first input to a second input, one switch is opened and another is closed. In one embodiment, care is taken to not have multiple drivers to the bus at one time. The bus can be pulled to some value when there is no switch driving the bus.

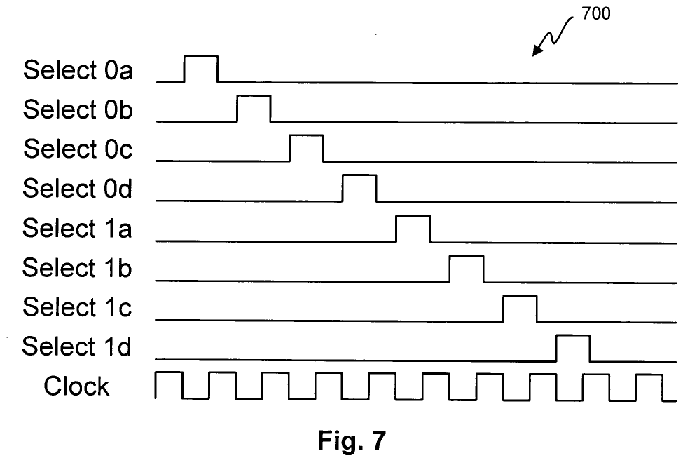

With reference to FIG. 7, a timing diagram 700 of an embodiment is shown that characterizes signals for a switching circuit 208-3. This timing diagram corresponds to the embodiment of FIG. 6. Each switch is sequentially closed and then opened in a manner such that the output is only driven by a single input at a given instant. For example, on the falling edge of the clock, Select0a activates to close the a switch in the first sub-multiplexer 600. After the rising edge of the clock, Select0a deactivates to open the a switch in the first sub-multiplexer 600. Next the Select0b activates to open the b switch also in the first sub-multiplexer 600. The output line from the switching circuit 208-3 could be input to a register that latches the value on the rising edge of the clock.

Other embodiments could have any number of layers of sub-multiplexers from one level to any practical maximum. Additionally, the whole analog multiplexer could be of any size, even though the discussed embodiments are 32 to 1. The sub-multiplexers could have any number of inputs in various embodiments, for example, 4, 8, 16, 32, 64, 128, 256, etc. Even though these various number of inputs are a number that is a power of two, the number of inputs could be any integer greater than one in other embodiments.

While the principles of the disclosure have been described above in connection with specific apparatuses and methods, it is to be clearly understood that this description is made only by way of example and not as limitation on the scope of the invention.

What is claimed is:

1. An image sensor for producing a moving or still picture, the image sensor comprising:
an imaging array,
a digital image processor,
a multiplexer coupled to both the imaging array and the digital image processor, wherein the multiplexer comprises:
a plurality of inputs,
a plurality of switches,
an output, and
a select function that selectively causes coupling of one of the plurality inputs to the output, wherein switching to any of the plurality of inputs results in a predetermined number of plurality of switches either opening or closing.

2. The image sensor for producing the moving or still picture as recited in claim 1, wherein the switches are arranged in at least one, two, three, four, five, or six levels.

3. The image sensor for producing the moving or still picture as recited in claim 1, wherein the image sensor is monolithically formed on a substrate.

4. The image sensor for producing the moving or still picture as recited in claim 1, wherein all of the plurality of inputs pass through a same number of switches when passing to the output.

5. The image sensor for producing the moving or still picture as recited in claim 1, wherein the multiplexer is coupled to an analog to digital converter (ADC).

6. An image sensor for producing a moving or still picture, the image sensor comprising:
an imaging array,
a digital image processor,
a multiplexer coupled to both the imaging array and the digital image processor, wherein the multiplexer comprises:
a plurality of inputs,
an output,
a plurality of switches arranged in levels, wherein all of the plurality of inputs pass through a same number of levels when passing to the output, and
a select function that selectively causes coupling of one of the plurality inputs to the output, wherein one of the plurality of switches in each level changes state when changing the select function from one of the plurality of inputs to another.

7. The image sensor for producing the moving or still picture as recited in claim 6, wherein the plurality of switches are arranged in sub-multiplexers that each have 2 or more inputs.

8. The image sensor for producing the moving or still picture as recited in claim 6, wherein the image sensor is monolithically formed on a substrate.

9. The image sensor for producing the moving or still picture as recited in claim 6, wherein switching to any of the plurality of inputs results in a predetermined number of plurality of switches either opening or closing.

10. The image sensor for producing the moving or still picture as recited in claim 6, wherein the multiplexer is coupled to an analog to digital converter (ADC).

11. An image sensor for producing a moving or still picture, the image sensor comprising:
an imaging array,
a digital image processor,
a multiplexer coupled to both the imaging array and the digital image processor, wherein the multiplexer comprises:
a plurality of inputs,
an output,
a plurality of switches arranged in levels, and
a select circuit that selectively causes coupling of one of the plurality inputs to the output, wherein one of the plurality of switches in each level changes state when changing the select function from one of the plurality of inputs to another.

12. The image sensor for producing the moving or still picture as recited in claim 11, wherein all of the plurality of inputs pass through a same number of levels when passing to the output.

13. The image sensor for producing the moving or still picture as recited in claim 11, wherein the plurality of switches are arranged in sub-multiplexers that each have 2 or more inputs.

14. The image sensor for producing the moving or still picture as recited in claim 11, wherein the image sensor is monolithically formed on a substrate.

15. The image sensor for producing the moving or still picture as recited in claim 11, wherein switching to any of the plurality of inputs results in a predetermined number of plurality of switches either opening or closing.

16. The image sensor for producing the moving or still picture as recited in claim 11, wherein the multiplexer is coupled to an analog to digital converter (ADC).
